(19) United States
(12) Patent Application Publication
(10) Pub. No.: US 2008/0083242 A1
(43) Pub. Date: Apr. 10, 2008

(54) LOCKING MEANS FOR LOCKING THE INNER CHAMBER OF A DEVICE AND DEVICE WITH LOCKING MEANS

(75) Inventors: Volker Muller, Hilchenbach (DE); Jorg Peter, Siegen (DE)

Correspondence Address: PEARNE & GORDON LLP, 1801 EAST 9TH STREET, SUITE 1200, CLEVELAND, OH, 44114-3108, US

(73) Assignee: DOMETIC GMBH, Siegen (DE)

(21) Appl. No.: 11/868,646

(22) Filed: Oct. 8, 2007

(30) Foreign Application Priority Data
Oct. 9, 2006 (DE) 10 2006 047 715.4

(51) Int. Cl. E05B 47/02; F25D 11/00; F25D 23/12

(52) U.S. Cl. 62/331; 70/278.7

(57) ABSTRACT

The invention describes an electromagnetically actuated locking means of simple mechanical construction for camping and leisure vehicles in particular, by which household appliances can be locked automatically. Therein, a mechanical bolt preferably is actuated via the ignition only and, in standard operation of the device when said leisure vehicle is parked, is not in engagement with a holding element on a door of a refrigerator e.g. Preferably, said locking means comprises a control and detectors for the position of said bolt engaging into a holding means, as well as a detector for detecting an opened or closed condition of said door. Furthermore, said locking means preferably comprises an illumination means and a communication interface by which functionality of the means can be checked and by which the individual function of said locking means can be addressed and/or detector signals can be interrogated.

The invention pertains to a locking means for locking the inner space of a device, said inner space usually being closed using a closing member like a door, a slide member, a flap, a roll front or the like.

Such locking means are required in house appliances or household appliances in particular, in which during operation no access to the inner space it to be possible for the operating person, like e.g. washing machines, microwave appliances, dishwashers or similar devices. Either there arise dangers for the operating person in case of opening the appliance during operation or resources/operating material of the appliance may exit to environment.

A particular demand for locking means also exists when devices are used in dynamic environment, like e.g. on ships, airplanes, trains or leisure vehicles. In this context, leisure vehicles are to be understood as caravans as well as self-moving motor caravans and water vehicles (like e.g. yachts).

In particular when used in road traffic, special requirements of the Road Traffic Regulations, regulating definite safety regulations with respect to occurring acceleration and retardation forces and load of the locking mechanism of the locking means have to observed, such that during acceleration or retardation of a leisure vehicle the contence of a refrigerator e.g. can be reliably held back by the locking element and the locking means. In this connection from Prior Art up to now mechanical lockings crystallized, in which in the region of the door a locking hook actuable mechanically and engaging with a lock latch or trap mounted in the area of the inner space of the device on the closing means, is mounted as locking element.

Locking means of this kind have the drawback that they have to be actuated mechanically and corresponding release mechanisms actuating said closing hooks have to be provided for. In addition, said release mechanism for the locking means have to be designed with such construction that the account for different stop sides of doors in household appliances. From DE 10 2005 017 870 A1, e.g. a locking means is known, in which a holding means which can be locked by means of an solenoid and using a gate shift is arranged in the area of a lock for a house appliance. A locking hook which is provided for on a door e.g. can, therefore, no longer exit from the holding element as the latter is blocked.

Such mechanical locking elements being locked electromagnetically, however, include the disadvantage that in case of continuous use of a household appliance like a refrigerator have a disadvantageous effect on the impression of comfort the user has of the appliance, as he has to overcome e a mechanical resistance during opening and closing. In household appliances the operator is used to having to overcome the resistance of a magnetic seal only and then to being able to open a refrigerator door easily. Furthermore, the mechanics shown in the State of the Art are complex and subsequently are rather subject to defects in case of frequent use.

On basis of this prior art the invention has to goal of stating a more comfortable locking means for a device with inner space and a device with locking means.

In accordance with the present invention this object with respect to the locking means is solved by the features of patent claim 1 and with respect to the device by the features of patent claim 13.

Preferred embodiments of the invention are stated in the depending claims 2 to 12.

In particularly advantageous manner a locking means in accordance with the present invention comprises a bolt engaging with a holding element arranged on a locking element. The holding element does not show any protruding portions and, therefore, the locking means in case of frequent opening and closing is not subject to mechanical load. Moreover, the locking means in accordance with the present invention in advantageous manner comprises a solenoid actuating the bolt. This manner of actuation is more simple in mechanics as compared to prior art and for this reason also more reliable since it does without excess mechanical elements.

A further development of the locking means in accordance with the present invention preferably comprises a detector by means of which orientation of the bolt is detected, which a bolt signal is switched. Thus it can be detected by means of a remote evaluation whether the locking means is locked or whether it is opened.

Advantageously, in a further development of the locking means in accordance with the present invention the bolt is arranged on a crankshaft, said crank being mechanically pretensioned such that preferably the two orientations of the bolt are stabilized mechanically.

The transfer between the two orientations of the bolt is effected in particularly advantageous manner by using a rocker button, the rocker button being directly or indirectly actuated by a solenoid. A means of this kind is extremely reliable in terms of mechanics. This, e.g. also is known from actuation of a ball pen.

In particularly advantageous manner in a further development of the locking means in accordance with the present invention in the area of the locking means a second detector for detection of the existence of the holding element is arranged on the device, said detector switching a locking signal. In this manner it can be found reliably in advantageous manner, whether the locking element, i.e. the door, is closed or opened. This information can be used for remote diagnostics, for safety switching off or an alarm, for control of inner space illumination and for definitely switching given locking conditions also in connection with the bolt signal.

In a particularly advantageous further embodiment of the locking means in accordance with the present invention in the area of the locking means an illumination means switched using the locking signal is arranged. In this manner additional cabling for illumination can be done without and the locking signal can in addition be used for switching the illumination means.

In a particularly advantageous further development of the locking means in accordance with the present invention the solenoid is actuable from outside so that e.g. by remote control locking or release of the locking means can be effected, e.g. from the driver's cabin of a camper, or as well a locking means can be released in that a switch is provided for in an area which is accessible for children as well.

In particularly advantageous manner a further development of the locking means in accordance with the present invention provides that the solenoid can be selected in dependence on the bolt signal and the locking signal. Thus it can be made sure in preferred manner that the bolt is actuated only if the locking element, i.e. the door, is closed or it can be made sure in case of locking of the device and closed door that a locking operation can be carried out without problem, even if a rigid mechanical locking is provided for.

In a particularly preferred further development of the locking means in accordance with the present invention it is provided for that the solenoid is selected by an ignition-on signal of a vehicle. Thus, it can be made sure in advantageous manner upon starting of a camper, e.g., that the refrigerator e.g. is locked automatically.

In particularly advantageous manner a further development of the locking means in accordance with the present invention provides that all components required for the locking operation are collected into one compact housing which also includes a control means. In this manner the locking means can be manufactured in compact manner and can be traded with in form a one device and can be arbitrarily mounted in an optimum position in the device.

In particularly advantageous manner in a further development of the locking means in accordance with the present invention the detectors are embodied as reed switches which are actuated without being touched as in this manner no mechanical load is caused by the detectors and long-term stability is guaranteed since the detectors are not subject to wear. And the output signals of reed switches are reliably evaluable using an electronic control circuit, as well.

In particularly advantageous manner a further development of the locking means in accordance with the present invention provides that a communication interface is arranged on the locking means, since in this manner all detected signals and status signals of a control can be fed to outside or control signals from outside can be supplied to the control.

Furthermore, it is provided for in advantageous manner that the locking element of the device can be locked also in case of locked condition of the bolt and after locking of said locking element it is locked as well.

The locking means in accordance with the present invention is particularly advantageously made use of in a device, a refrigerator in particular, in a leisure vehicle, since there reliably all advantages of the invention are effective.

In the following the invention will be further described with reference to embodiments and figures.

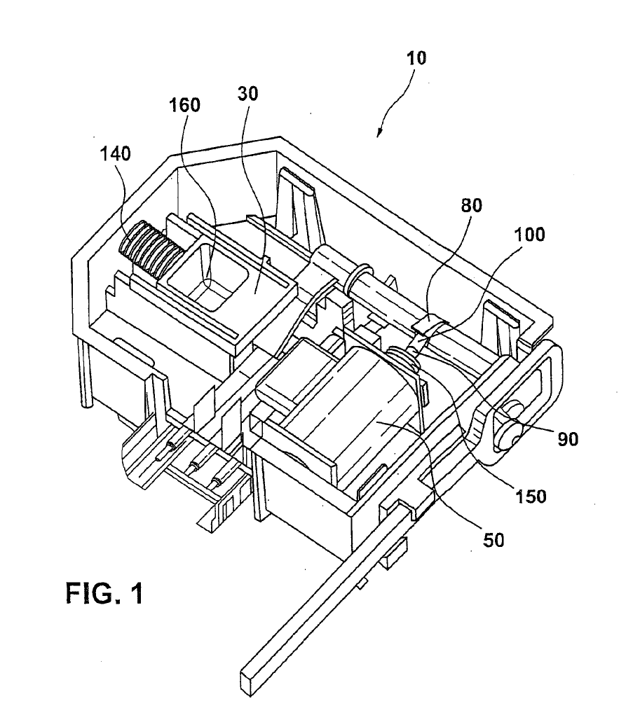

FIG. 1 shows a lock for a house appliance under the prior art.

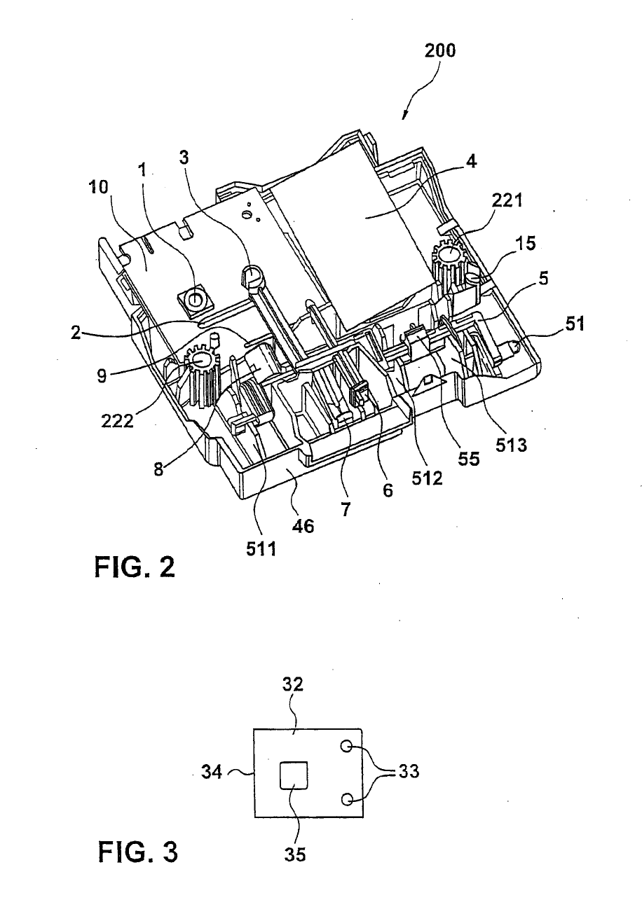

FIG. 2 shows a locking means for locking the inner space of a device in accordance with an embodiment of the present invention.

FIG. 3 shows a holding element arranged in the area of a closing element of the device, in accordance with an embodiment of the present invention.

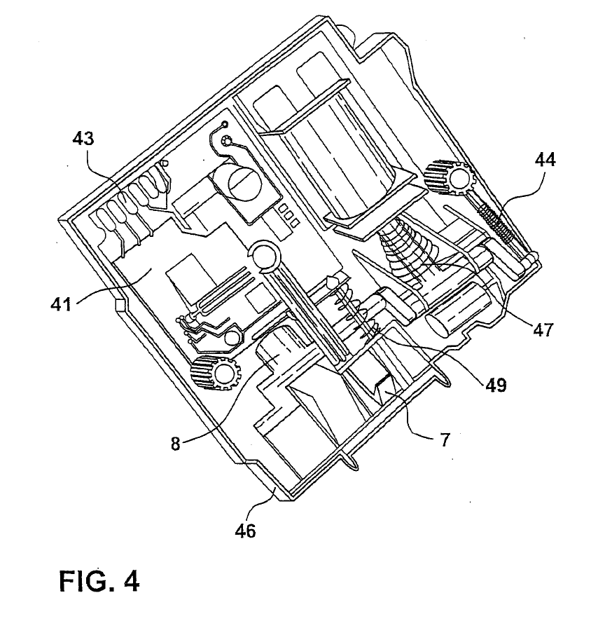

FIG. 4 shows a perspective view of a locking means in accordance with an embodiment of the present invention.

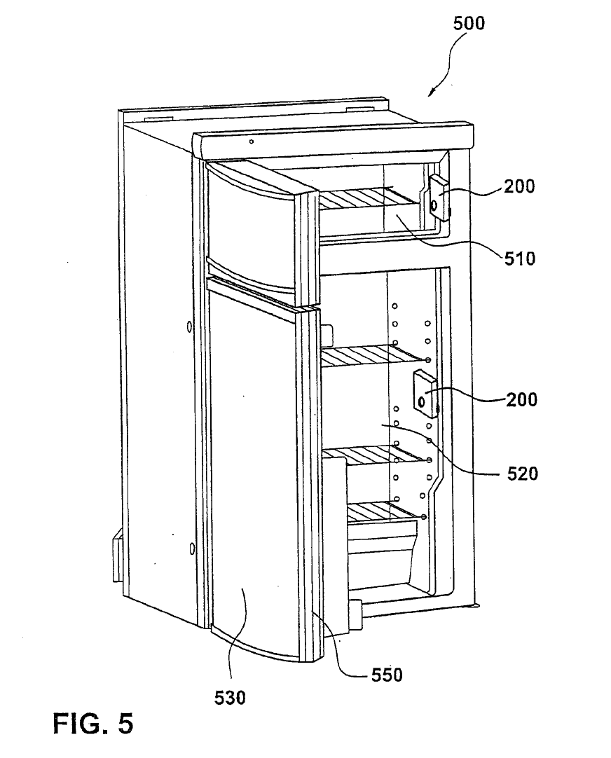

FIG. 5 shows a built-in refrigerator for a camping vehicle as device using two locking means in accordance with the present invention at two different doors as closing elements.

FIG. 1 shows a lock for a house appliance, as shown in DE 10 2005 017 870 A1. The lock 10 shown there comprises a holding element with a recess 160 into which a bolt engages, said holding element being referred to by 30. In addition, from the representation a solenoid 50 with actuation tappet 90 can be seen, said tappet being guided back via a pressure spring 150. On an actuation shaft with gate 100 a switching rocker 80 is located, into which said tappet 90 engages for turning said shaft. It can be clearly seen that said holding element 30 is pretensioned by a spring 140 and that the locking mechanics are of expensive construction.

In the state of art a movement of said holding element 30 against said spring 15 is caused by actuation of said shaft via said gate 100 such that a locking hook engaging with said holding element can no longer be removed from the latter.

FIG. 2 shows an embodiment of a locking means 200 in accordance with the present invention. On said locking means fixation elements 221 and 222 are located by means of which said locking means can be fixed to the inner space of a device on the housing. Furthermore, said locking means comprises an inner space illumination in form of a light emitting diode 1. As well, a crank shaft 5 of simple mechanical construction can be recognized, a crank 51 being arranged thereon. Said crank shaft is rotatably and mechanically stably supported on bearing positions 511, 512 and 513 in said housing 46. Between said crank 51 and a fixation position 15 a tension spring can be arranged for mechanically pretension said crank for mechanically stabilizing said crank in two bolt positions. Furthermore, a locking hook or bolt 7, respectively, can be clearly seen, which engages into a holding means shown in FIG. 3 in the area of said closing element when said locking means is actuated. As well, a first detector 9 can be seen, which in connection with a magnet 8 issues a bolt signal from which the orientation of said bolt can be detected.

In addition, a second detector 2 can be seen, which is actuated via a magnet 1 carrying out locking detection via a slide 6 when said holding element when said holding element upon engagement into said locking means shifts said slide across said detector 2 and thus said magnet e.g. actuates a reed switch.

Furtheron, schematically in the area of said housing 46 a control board 10 is shown which contains micro circuits serving for control of said locking means and for evaluation of the signals supplied by said detectors. In FIG. 2 the mechanically simple construction of the locking means in accordance with the present invention can be clearly seen since in this embodiment said bolt 7 is actuated via said shaft 5 directly.

In particularly advantageous manner, it can be seen from FIG. 2 as clearly that here a slide 6 is arranged, which actuates said second detector so that several functions are compactly combined in one housing and e.g. also an illumination circuit is contained in the housing of said locking means 200.

In this context is has to be noted that statuses of said detectors 2 and 9 can be detected by said control on said control board 10 or via a contact not shown here, as interface to outside. When said magnet 8 is located opposite to said detector 9, said bolt 7 is opened. I.e. when said reed switch 9 issues a signal, said bolt is opened. If said reed switch 9 does not issue a signal, said bolt is locked i.e. it is in lifted position whereby said magnet 8 is lowered. This condition can be seen in FIG. 4 more clearly. In contrast thereto, said detector 2 which is actuated via a magnet 3 when it is embodied as reed switch issues a signal if said locking element is opened, i.e. said slide 6 is not actuated. This condition can also be clearly seen from FIG. 4, where said magnet is located directly above said reed switch.

Advantageously, said switching signal can be used for activating said light emitting diode. It can also be seen from the representation that an holding element which is inserted into the housing in the area of said bolt 7 shifts said slide 6 in backward direction and thus removes said magnet 3 from said detector 2. Thereby a spring 49 shown in FIG. 4 is pretensioned.

Of course, arbitrary other modifications of detectors and switching conditions can be realized in connection with the present invention.

FIG. 3 shows an example of a holding element in the area of a locking element in accordance with the present invention. E.g. fixation bores 33 are provided for, by which said holding element 32 can be fixed to a door using screws or rivets or other fixation means. It is characteristic that said holding element 32 comprises an opening 35 into which said bolt 7 shown in FIG. 2 engages upon actuation.

Advantageously, thus e.g. a user is given the impression that he handles a standard household refrigerator, provided the locking means in accordance with the present invention is not actuated, since said holding means is embodied as plate or thin sheet which enter or leave said locking means without substantial mechanical contact. With a front face 34 it does e.g. therein actuate said slide 6 shown in FIG. 2 for causing a locking signal.

FIG. 4 advantageously shows a further representation of the locking means in accordance with the present invention. Especially, in FIG. 4 the opened housing 46 is shown and springs 44, 47 and 49 can be clearly seen. Said spring 44 therein stabilizes said crank shaft 5 shown in FIG. 2, in two orientations which can be caused by said magnet 4 in known manner via a switch gate. Here it can also be clearly seen that said bolt 7 is in locked position, said magnet 4 being tilted in downward direction so that it does not actuate said detector 9. Here, too, a circuit 41 can be clearly seen as well as communication contacts 43 through which communication with said circuit 41 from outside is possible and through which current can be supplied to the circuit. In this example in accordance with the present invention the circuit controlled by microprocessor can carry out all functions for controlling the locking means in accordance with the present invention and for evaluating the signals supplied by the detectors.

It further is possible that diagnostic signals are sent to outside in order to be able to check the functioning of the circuit in most simple manner. In particularly advantageous manner said locking means in accordance with the present invention is operated with 12 V direct current and, particularly advantageous, it is possible to start the locking operation using a signal issued with switched-on ignition, i.e. usually with applied D+. In particularly advantageous manner said magnet in said locking means is embodied as monostable magnet. Particularly advantageously, said locking means in accordance with the present invention can be used in absorption refrigerating units for boats, motor caravans and caravans, hotels and similar places.

In particular when used in hotels, said circuit 41 can be used also for evaluating the filling condition of a minibar, wherein status signals characterizing the filling conditions of individual places in the minibar, are supplied via said outside contact 43. If required special programs have to be loaded into the memory of the control and corresponding evaluation routines have to be made available additionally.

In further advantageous manner said locking means in accordance with the present invention includes an urgency release via a button so that even in case of applied D+, i.e. ignition of the vehicle is switched on and the engine is running, access is possible to the refrigerator.

In further advantageous manner said circuit in accordance with the present invention is designed such that it has a closed circuit consumption being as low as possible, which e.g. is made sure via a sleeping mode during which said circuit consumes less than 10 μA.

FIG. 5 shows as example an built-in refrigerator for a leisure vehicle 500 comprising a froster compartment 510 and a standard cooling compartment 520. In the area of said refrigerator 500 two locking means in accordance with the present invention are installed and marked with reference nos. 200. When said locking means is not actuated, the closing element, in this case the refrigerator door, is held closed by a magnetic seal 550 as known from household appliances.

With the above description an extremely simple and compact locking means for devices with inner space is described, which can be traded with as compact unit. In particularly advantageous manner said locking means comprises several detectors for detecting conditions of said bolt, as well as of said closing element and an integrated illumination unit, as well as a control with a communication bus which can be interrogated from outside. Mechanical wear is minimized by an optimation of said locking means in accordance with the present invention to operation as touch-free as possible, and accordingly the simple construction also guarantees reliable long-term operation.

1: A locking means (200) for locking the inner space of a device (500), comprising:
a bolt (7) is arranged on said device (500),
a holding member (32) cooperating with said bolt (7) during locking is arranged on a closing element (530) sealing the inner space of said device (500)
said bolt (7) comprises two preloaded stable orientations, wherein in a first orientation said bolt (7) releases said holding element (32) and in said second orientation said bolt (7) locks said holding element (3) and the mechanical arrangement between belt (7) and holding element (32) is designed such that during closing of said closing element (530), when said bolt (7) is in said first orientation, a gap remains between said bolt (7) and said holding element (32),
said bolt is actuated using a solenoid.

2: The means as defined in claim 1, wherein said bolt (7) is in effective connection with a first detector (9, 8) for detecting orientation, switching a bolt signal.

3: The means as defined in claim 1, wherein said bolt (7) is arranged on a crank shaft (6), one crank being mechanically preloaded.

4: The means as defined in claim 3, wherein on said crank shaft (5) a switch gate (55) is arranged, for reciprocating between two orientations and said switch gate (55) during switching is in effective connection with said solenoid.

5: A means as defined in claim 2, wherein in the area of said locking means (200) on said device (500) a second detector (2, 3) for detection of presence of said holding element (32) is arranged, which switches a locking signal.

6: A means as defined in claim 5, wherein an illumination means (1) switched using said locking signal is arranged on said locking means (200).

7: A means as defined in claim 5, wherein said solenoid (4) can be addressed from outside of said locking means.

8: A means as defined in claim 7, wherein said solenoid (4) can be addressed in dependence on said bolt signal and said locking signal.

9: A means as defined in claim 8, wherein said solenoid (4) can be addressed using an ignition-on signal of a vehicle.

10: A means as defined in claim 1, wherein the components of said locking means (200), arranged on said device are combined in a housing (46) and said housing comprises a control means (10, 41).

11: A means as defined in claim 5, wherein said detectors (2, 3, 8, 9) are embodied as reed switches.

12: A means as defined in claim 11, wherein a communication interface (43) is arranged, through which said detector signals and control functions can be communicated.

13: A means as defined in claim 1, wherein said closing element (530) of said device (500) also can be locked in locked condition of said bolt (7) and after closing of said closing element (530) this one is locked as well.

14: A refrigerator, in a camping vehicle with a means as defined in claim 1.
